(19) United States
(12) Patent Application Publication
(10) Pub. No.: US 2004/0032509 A1
(43) Pub. Date: Feb. 19, 2004

(54) Camera having audio noise attenuation capability

(76) Inventors: James W. Owens, Ft. Collins, CO (US); Andrew C. Goris, Loveland, CO (US)

Correspondence Address: HEWLETT-PACKARD COMPANY, Intellectual Property Administration, P.O. Box 272400, Fort Collins, CO, 80527-2400, US

(21) Appl. No.: 10/222,292

(22) Filed: Aug. 15, 2002

(51) Int. Cl. H04N 5/228; H04N 5/217; H04N 5/76

(52) U.S. Cl. 348/222.1; 348/241; 348/231.4

(57) ABSTRACT

A camera having audio noise attenuation capability is disclosed. In one embodiment, the camera comprises a microphone and an audio noise attenuation system configured to attenuate undesired noise captured by the microphone when recording audio. In some embodiments, the audio noise attenuation system facilitates attenuation of noise generated by a motor of the camera. In other embodiments, the noise attenuation system generation facilitates attenuation of audio noise from the environment in which the camera is used.

### BACKGROUND

Many digital cameras now comprise microphones that facilitate the recording of audio. Such audio may comprise a brief memo to be stored with a particular image or, where the digital camera is so configured, audio associated with video sequences when the camera is operating in a “movie” mode.

Most of these cameras include motors that control various camera functions. For example, a zoom motor may control displacement of an external zoom lens, another motor (or the same motor) may control an auto-focus mechanism, and so forth. Due to the provision of the camera microphone in relatively close proximity to the motor(s), the noise created by operation of the motor(s) may be unintentionally stored during audio recording, thereby significantly degrading the quality of audio captured by the camera.

Several solutions are currently available for avoiding capture of camera motor noise. For instance, some cameras inhibit use of the microphone while a motor is operating, or vice versa. Therefore, if the user wishes to capture audio, the user must adjust focus and/or zoom before recording any sound. In another solution, a digital zoom feature is provided which the user can use to “zoom” in on a scene without the operation of a zoom motor. Unfortunately, however, such “zooming” merely comprises cropping the captured image and enlarging it. Therefore, the resolution of the image is decreased.

Other solutions may be implemented. For instance, the camera motors can be insulated (e.g., by placing them deep within the camera body) to attenuate the amount of noise that the microphone picks up. This solution, however, would likely increase the size of the camera, as well as the cost. In another potential solution, the microphone can be made separate from the camera body so that it can be held remotely from the motor. This solution is also undesirable, however, in that it requires the user to carry and operate two separate components as opposed to just one.

In view of the above, it can be appreciated that it would be desirable to have a camera that is capable of attenuating audio noise, for instance generated by a camera motor, so that higher quality audio can be captured by the camera.

### SUMMARY

The present disclosure relates to a camera having noise attenuation capability. In one embodiment, the camera comprises a microphone and a noise attenuation system configured to attenuate undesired noise captured by the microphone when recording audio.

In some embodiments, the noise attenuation system facilitates attenuation of noise generated by a motor of the camera. In other embodiments, the noise attenuation system facilitates attenuation of noise from the environment in which the camera is used.

### BRIEF DESCRIPTION OF THE DRAWINGS

FIG. 1 is a is a schematic perspective view of a digital camera that includes noise attenuation capabilities.

FIG. 2 is a block diagram of an example embodiment for the camera of FIG. 1.

FIG. 3 is a flow diagram of an embodiment of operation of the camera in which noise is attenuated.

FIG. 4 is a flow diagram of an embodiment of filter adjustment in an adaptive filtering scheme.

### DETAILED DESCRIPTION

As identified in the foregoing, audio noise generated by the operation of camera motors can degrade audio captured with the camera. In that existing solutions present other disadvantages, what is needed is a camera that is capable of attenuating such noise so that higher quality audio can be captured.

Disclosed herein is a camera that includes an audio noise attenuation system that can be used to attenuate, or even cancel, such noise. As will be described in greater detail below, this system can comprise one or more audio noise filters that are created in relation to one or more audio noise signatures captured by the camera, for instance at camera power up.

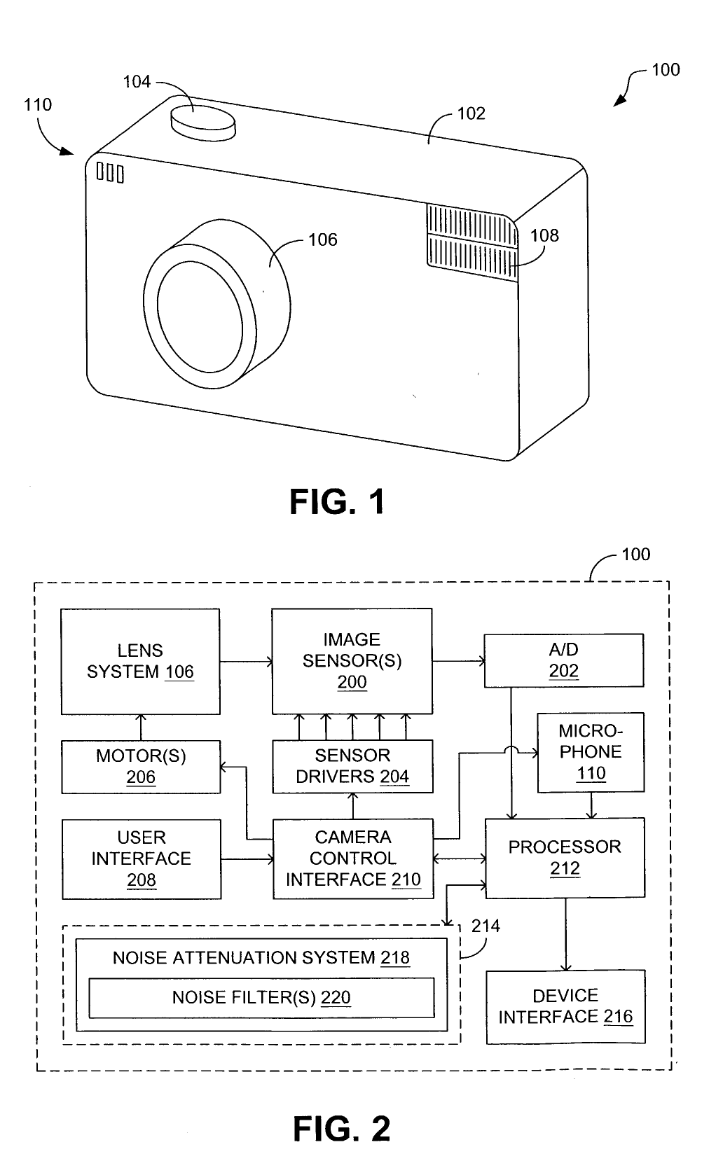

Referring now to the drawings, in which like numerals indicate corresponding parts throughout the several views, FIG. 1 illustrates an example camera 100 that incorporates a noise attenuation system. By way of example, the camera 100 comprises a digital still camera. Although a particular configuration is shown for the camera 100 in the figure and is described herein, it is to be understood that the camera is merely representative of one example camera embodiment.

As indicated in FIG. 1, the camera 100 can include a camera body 102, a shutter release button 104, a lens system 106, a flash 108, and a microphone 110. By way of example, the lens system 106 comprises a zoom lens that, as is known to persons having ordinary skill in the art, can be zoomed in and out using an internal motor. As shown in FIG. 1, the microphone 110 can be integral with the camera body 102.

FIG. 2 provides a block diagram of an example architecture for the camera 100 of FIG. 1. As indicated in this figure, the camera 100 includes the lens system 106 and microphone 110 identified above and can further include one or more image sensors 200, an analog to digital (A/D) converter 202, sensor drivers 204, one or more camera motors 206, a user interface 208, a camera control interface 210, a processor 212, camera memory 214, and a device interface 216. The lens system 106 comprises one or more lenses that focus images of viewed objects on the image sensor 200. By way of example, the image sensor 200 comprises a solid-state sensor such as a charge-coupled device (CCD). The sensor 200 is clocked by the sensor drivers 204 to produce analog image signals corresponding to still images of the viewed objects. These image signals are converted to digital image signals by the A/D converter 202. The digital image signals are then processed by the processor 212 and stored in memory, such as a removable solid-state memory card (not shown), which connects to the camera 100 via the device interface 216.

The user interface 208 comprises one or more components available to the user for controlling operation of the camera 100. For instance, the user interface 208 can comprise the shutter-release button 104 identified in relation to FIG. 1. The camera control interface 210 receives commands input via the user interface 208 and controls basic operation of the camera 100. The processor 212 is responsible for processing the image and audio data captured by the image sensor 200 and the microphone 110, respectively, and stores these data in memory.

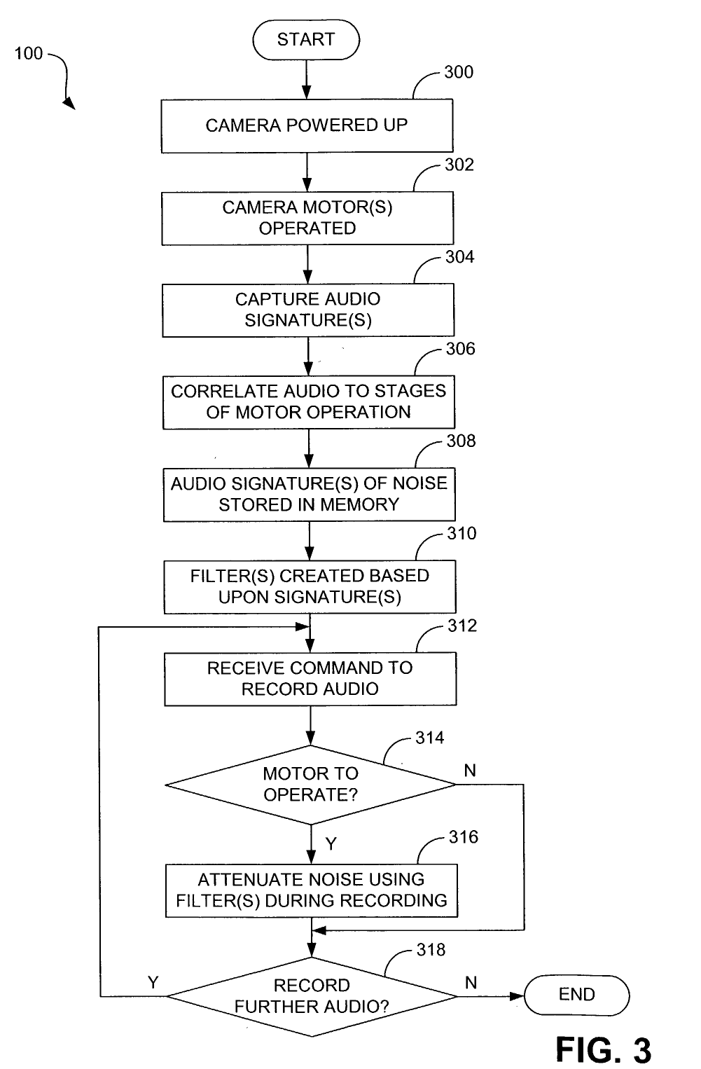

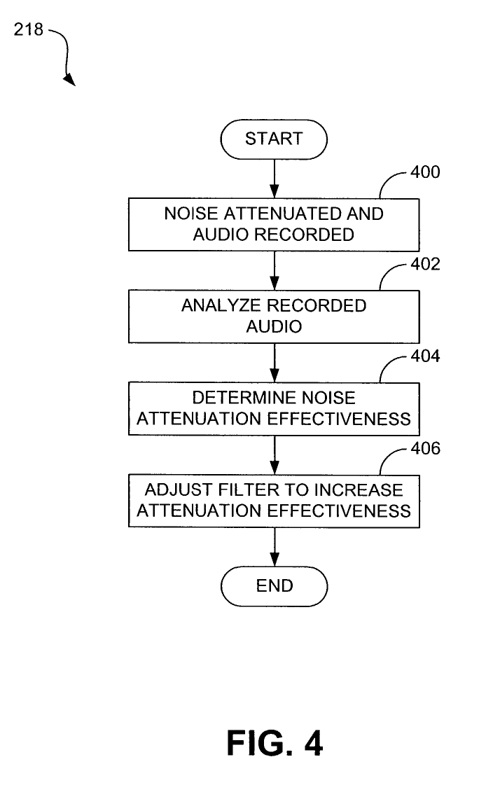

The memory 214 contains at least a noise attenuation system 218 (in software or firmware) that, as is discussed in greater detail below, is used to attenuate various undesired noise generated by the camera, the environment in which the camera is used, or other sources. As indicated in FIG. 2, the noise attenuation system 218 can include a noise filter 220 that is used to attenuate undesired noise. Generally speaking, the noise filter 220 can comprise any filter that is capable of attenuating a given frequency or range of frequencies of sound. By way of example, the filter 220 comprises a notch filter that is tuned to the interfering noise frequency or frequency range. To account for frequency drift, the filter 220 can, optionally, be adjusted using an adaptive noise attenuation algorithm, such as a least-mean-square (LMS) algorithm. Examples of implementation of such an algorithm are described in Adaptive Filter Theory, 3^{rd} Edition, by Simon Haykin, on pages 365-385, which are hereby incorporated by reference into the present disclosure. In an alternative arrangement, the noise filter 220 can comprise an active noise cancellation filter of known construction which dynamically attenuates noise through the application of an applied inverse sound wave. Use and operation of the noise attenuation system 220 is described below in relation to FIGS. 3 and 4.

Various code (software and/or firmware) has been identified above. It is to be understood that this code can be stored on any computer-readable medium for use by or in connection with any computer-related system or method. In the context of this document, a computer-readable medium is an electronic, magnetic, optical, or other physical device or means that can contain or store code (e.g., in the form of a computer program) for use by or in connection with a computer-related system or method. The code can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. The term “computer-readable medium” encompasses any means that can store, communicate, propagate, or transport the code for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a nonexhaustive list) of the computer-readable media include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

An example camera 100 having been described above, examples of operation of the camera will now be discussed. In the discussions that follow, flow diagrams are provided. It is to be understood that any process steps or blocks in these flow diagrams may represent modules, segments, or portions of code that include one or more executable instructions for implementing specific logical functions or steps in the process. It will be appreciated that, although particular example process steps are described, alternative implementations are feasible. Moreover, steps may be executed out of order from that shown or discussed, including substantially concurrently or in reverse order, depending on the functionality involved.

FIG. 3 provides an example of operation of the camera 100 in attenuating undesired noise. In particular, illustrated is a method of noise attenuation in which one or more audio signatures of a given noise (interfering) input is first captured and an appropriate filter 220 created for attenuating the input. Beginning with block 300 of the figure, the camera 100 is first powered up. Next, one or more camera motors 206 are operated, as indicated in block 302. Where the camera 100 comprises more than one motor 206, such operation may comprise independently operating each motor, especially in situations in which each cannot be operated simultaneously.

Simultaneous to motor operation or immediately prior to it, the microphone 110 is activated to capture audio, as indicated in block 304. Typically, the noise generated by the motor 206 is captured from an initial mechanism position to an end position, and back again. Audio capture in this manner permits recordation of audio signatures of the motor 206 throughout the various stages of motor progression. For example, if the motor 206 is a zoom motor, it may generate a first frequency or range of frequencies of noise during zoom, in and a different frequency or frequency range of noise during zoom out. In addition, the noise generated by the motor 206 may be different as the motor accelerates when first activated or decelerates as it is powered down. As indicated in block 306, the noise created by the motor 206 can be correlated to each of these different stages for purposes of creating an appropriate filter for each. Alternatively, however, a single audio signature can be captured that is generally representative of motor noise.

With reference next to block 308, each of the audio signatures that pertain to the various stages of motor operation are stored in camera memory 214. As will be appreciated by persons having ordinary skill in the art, these signatures may include audio components representative of interfering noise from the environment, such as wind noise. In that filtration of this other noises is also desirable, storage of these audio components provides a corollary benefit in that such noise will also be attenuated.

Next, one or more noise filters 220 are created by the noise attenuation system 218, as indicated in block 310. These noise filters 220 are generated in view of the stored audio signatures that were captured in the manner described above. In particular, the filters 220 are configured so as to at least attenuate, and ideally cancel, the frequencies of audio contained in the audio signatures such that the filters can be applied when a camera motor 206 is operated simultaneous to audio recording using the camera microphone 110. As mentioned above, such a filter 218 may comprise a notch filter of known configuration.

Notably, the steps described in blocks 302 to 310 can be performed automatically immediately after camera power up. Performance of the steps after each power up may provide for more effective noise attenuation in that the noise generated by the camera motor 206 may change over time as the camera 110 is used. Alternatively or in addition to performing these steps during power up, these steps can be performed on user demand, for instance when a “recalibrate” command is received via the user interface 208. In such a scenario, environmental noise (e.g., wind) can be more accurately attenuated than if the audio signatures had been captured in a different (e.g., non-windy) environment (e.g., indoors).

Next, with reference to block 312, a command to record audio can be received via the user interface 208. It can then be determined, in decision block 314, whether a camera motor 206 will be operated simultaneous to such audio recording, as indicated by user input via the user interface 208. If no such simultaneous operation is to occur, there is no need to filter motor noise and flow continues down to decision block 318 described below. If, however, simultaneous recording and motor operation is to occur, the motor noise, and any other undesired audio component captured during recording of the audio signatures, is attenuated using one or more of the generated noise filters 220, as indicated in block 316. Assuming the correlation described above in relation to block 306 occurred, the proper filter 220 can be applied for each given stage of motor operation. For instance, where the motor 206 is being used to zoom in, a first filter 220 can be used and where the motor is being used to zoom out, a second filter can be used. As will be appreciated by persons having ordinary skill in the art, acceptable noise filtration results may be obtainable where a single filter 220 is generated by the noise attenuation system 220 that is representative of motor noise in general.

With reference now to decision block 318, it can be determined whether more audio is to be recorded. If not, flow for the noise attenuation session is terminated. If, on the other hand, further audio is to be recorded, flow returns to block 312 and continues from that point in the manner described above.

As can be appreciated from the above discussion, much if not all of the noise generated by a camera motor 206 can be filtered using the noise attenuation system 218. Therefore, higher quality audio can be recorded by the user while a focusing motor or zoom motor is operating. Persons having ordinary skill in the art will recognize that this methodology can be used to suppress other camera noises, such as the noise created by actuation of the aperture and the like. Indeed, the noise attenuation method described above can be used to filter non-camera noises such as wind noise alone. In such a case, excessive wind noise can be substantially removed from recorded audio even when a noise-generating camera component (e.g., motor) is not operating.

Most accurate attenuation results can be obtained where the applied filter 220 is adjusted using an adaptive filtering scheme. As noted above, such a result can be achieved using an LMS algorithm. FIG. 4 provides the flow for adjustment of a noise filter 220. Beginning with block 400, noise is attenuated using the filter 220 in the manner described in relation to FIG. 3, and audio is recorded. Next, the recorded audio is analyzed by the noise attenuation system 218, as indicated in block 402. This analysis may comprise generating an estimation of noise filtration error by comparing the recorded audio to the earlier captured audio signature. Through this comparison, the effectiveness of the noise attenuation can be determined, as indicated in block 404. This determination can be made by determining how much of the original audio signature is still present in the recorded audio. After this determination is made, the filter 220 is adjusted, as indicated in block 406, for example using an LMS algorithm in accordance with the estimation of error. Although an LMS algorithm has been specifically identified herein, persons having ordinary skill in the art will appreciate that other algorithms could be used to adjust the filter 220 to facilitate adaptive filtration. LMS algorithms are deemed particularly suitable, however, due to their accuracy and simplicity.

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A camera, comprising:
a microphone; and
an audio noise attenuation system configured to attenuate undesired audio noise captured by the microphone when recording audio.

2. The camera of claim 1, wherein the audio noise attenuation system comprises an audio noise filter.

3. The camera of claim 2, wherein the noise filter is a notch filter.

4. The camera of claim 2, wherein the noise filter is configured to filter frequencies associated with an audio signature of a camera motor.

5. The camera of claim 2, wherein the noise filter is configured to filter frequencies associated with environmental noise.

6. The camera of claim 2, wherein the noise attenuation system is configured to adjust the noise filter in relation to an estimation of noise filtration error.

7. The camera of claim 6, wherein the noise attenuation system comprises a least-mean-square (LMS) algorithm that is used to adjust the noise filter.

8. A digital camera capable of recording audio, comprising:
a lens system;
an image sensor configured to sense objects viewed with the lens system;
a motor that generates noise;
a microphone;
a control interface configured to control operation of the motor and the microphone;
a processor configured to receive image data from the image sensor and audio data from the microphone; and
memory comprising a noise attenuation system including a noise filter that is configured to attenuate the noise generated by the motor.

9. The digital camera of claim 8, wherein the noise filter comprises a notch filter.

10. The digital camera of claim 8, wherein the noise attenuation system is configured to facilitate capture of an audio signature of the motor and wherein the noise filter is specifically configured to attenuate frequencies of the audio signature.

11. The digital camera of claim 8, wherein the noise attenuation system is configured to facilitate capture of environmental noise and wherein the noise filter is configured to attenuate frequencies of the environmental noise.

12. The digital camera of claim 8, wherein the noise attenuation system is configured to adjust the noise filter in relation to an estimation of noise filtration error.

13. The digital camera of claim 12, wherein the noise attenuation system comprises a least-mean-square (LMS) algorithm that is used to adjust the noise filter.

14. A method for attenuating noise in a digital still camera, the method comprising:
operating a motor of the camera;
capturing an audio signature of the motor while it operates;
generating a noise filter configured to attenuate frequencies of the audio signature; and
applying the noise filter to audio recorded during operation of the motor.

15. The method of claim 14, wherein the step of operating a motor comprises operating one of a focusing motor and a zoom motor.

16. The method of claim 14, wherein the step of capturing an audio signature comprises capturing an audio signature with an integral microphone of the camera.

17. The method of claim 14, further comprising adjusting the noise filter to provide adaptive filtering.

18. The method of claim 17, wherein the step of adjusting the noise filter comprises adjusting the noise filter using a least-mean-square (LMS) algorithm.

19. A system for attenuating noise in a digital still camera, the system comprising:
means for operating a motor of the camera and simultaneously capturing an audio signature of the motor;
means for generating a filter configured to attenuate frequencies of the audio signature; and
means for applying the noise filter to audio recorded during motor operation so as to attenuate the frequencies of the audio signature.

20. The system of claim 19, wherein the means for generating a filter comprise a noise attenuation system stored within camera memory.

21. The system of claim 20, wherein the noise attenuation system comprises means for adjusting the noise filter.

22. The system of claim 21, wherein the means for adjusting the noise filter comprise a least-mean-square (LMS) algorithm.

23. A noise attenuation system stored on a computer-readable medium, comprising:
logic configured to facilitate operation of a camera motor;
logic configured to facilitate capture of an audio signature of the motor; and
logic configured to generate a noise filter that attenuates frequencies of the audio signature.

24. The system of claim 23, further comprising logic configured to apply the generated noise filter to recorded audio during motor operation to attenuate frequencies associated with the audio signature of the motor.

25. The system of claim 23, further comprising logic configured to adjust the noise filter.

26. The system of claim 25, wherein the logic configured to adjust the noise filter comprises a least-mean-square (LMS) algorithm.
